(19) United States
(12) Patent Application Publication
(10) Pub. No.: US 2001/0048796 A1
(43) Pub. Date: Dec. 6, 2001

(54) Optical flat cable

(76) Inventors: Anton Ludl, Freiberg (DE); Klaus Nothofer, Erkrath (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/784,017

(22) Filed: Feb. 16, 2001

(30) Foreign Application Priority Data
Feb. 18, 2000 (DE) 100 07 366.2

(51) Int. Cl. G02B 6/44

(52) U.S. Cl. 385/114

(57) ABSTRACT

An optical flat cable with two optical waveguide elements and at least two tension/compression elements is described, the optical waveguide elements and the tension/compression elements being arranged in a common sheath. The optical waveguide elements (are arranged in the sheath spaced from one another, and in each case at least one tension/compression element is arranged extending in parallel to, and in the direct vicinity of, each optical waveguide element.

### BACKGROUND

The invention relates to an optical flat cable with two optical waveguide elements and at least two tension/compression elements, wherein the optical waveguide elements and the tension/compression elements are arranged in a common sheath.

So-called subscriber connection cables are used to connect new subscribers to the subscriber network. Such subscriber connection cables connect the distributor cable (local cable) to a building. In a glass fibre network the subscriber connection cables comprise only a few optical fibres.

“Journal of Lightware Technology” Vol. 16, No. 2, Feb. 1998, p. 209 has disclosed an optical flat cable comprising an optical waveguide arranged centrally in a synthetic resin casing and two tension/compression elements likewise arranged in the sheath spaced from the optical waveguide. A construction of this type is provided as indoor cable, underfloor cable or termination cable.

“Journal of Lightware Technology” Vol. LT-5, No. 6, June 1987, p. 815 has disclosed an optical flat cable with two optical waveguides extending centrally in a synthetic resin sheath. Two tension/compression elements are likewise

This cable is to be used as drop cable, indoor cable or underfloor cable.

### DESCRIPTION

The object of the present invention is to make available an optical flat cable which is light, can be produced cost-effectively, can be easily installed, has small dimensions and therefore is optically unobtrusive, and in which the optical waveguide elements are easily accessible.

This object is achieved by in that the optical waveguide elements are arranged in the sheath spaced from one another, and in each case at least one tension/compression element is arranged extending in parallel to, and in the direct vicinity of, each optical waveguide element.

In addition to the advantages directly resulting from the object of the invention, the cable according to the invention also has the advantage that tensile- and lateral forces are withheld from the optical waveguide. As the tension/compression elements are arranged in the direct vicinity of the optical waveguide elements, the tension/compression elements can be used as rupture wires to facilitate the installation of the optical waveguides.

The, fact that the optical waveguides are arranged spaced from one another enables the cable easily to be attached to walls without any risk of damage to the optical waveguides. Due to the provision of the tension/compression elements, bends required in the case of indoor installation are not impeded.

The optical waveguides can consist of optical glass fibres or also of optical synthetic resin fibres. The relatively short distances at the subscriber end mean that the greater attenuation of the optical synthetic resin fibres is not of great importance.

Further advantageous developments of the invention are described in the sub-claims.

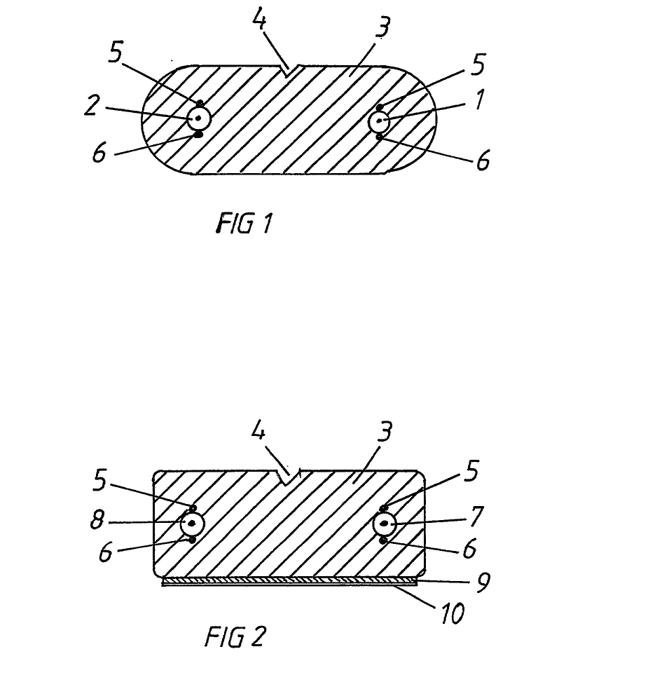

The invention is explained in detail in the form of the exemplary embodiments schematically illustrated in FIGS. 1 and 2.

FIG. 1 illustrates a cable according to the theory of the invention which is preferably used as exterior cable.

The cable consists of two tight buffer tubes 1 and 2 which are arranged in a common sheath 3 spaced from one another. The cable is of flat formation and can be attached by its flat side for example to a building wall. A notch 4 in the side opposite the flat side serves both as identification aid for the fibre and also as installation aid when the cable is to be attached for example by nails to the building wall.

In the case of exterior cables the sheath 3 preferably consists of UV-resistant polyethylene.

In the direct vicinity of the tight buffer tubes 1 and 2 two tension- and compression elements 5 and 6 are arranged diametrically, these being in direct contact with the tight buffer tubes 1 and 2 along the entire length of the tight buffer tubes 1 and 2.

The tension- and compression elements 5 and 6 can consist of steel wires or also of rods composed of glass-fibre-reinforced synthetic resin.

The tension- and compression elements 5 and 6 serve as so-called rupture wires by means of which the sheath 3 can be opened in order to render accessible, and install, the tight buffer tubes 1 and 2.

The cable illustrated in FIG. 2 is used predominantly as an indoor cable.

Here the optical waveguide elements consist of the loose- or multifibre buffer tubes 7 and 8 which are arranged in the sheath 3.

In the case of an indoor cable the sheath 3 preferably consists of fire-resistant polyvinyl chloride to prevent flames spreading in the event of a fire. However other fire-resistant materials, such as polyethylene with aluminium trioxyhydrate (ATH) additives, can also be used.

Here again a notch 4 serves as installation aid. The surface opposite the notch 4 is provided with a coating 9 of an adhesive, with the aid of which the cable can be adhesively attached to a building wall. Prior to the installation of the cable a removable protective film 10 is applied to the adhesive coating 9.

The cable according to the theory of the invention has a width of 5-8 mm and a height of 3-4 mm. Therefore it is unobtrusive following installation.

1. An optical flat cable with two optical waveguide elements and at least two tension/compression elements, wherein the optical waveguide elements and the tension/compression elements are arranged in a common sheath, characterised in that the optical waveguide elements are arranged in the sheath spaced from one another, and in each case at least one tension/compression element is arranged extending in parallel to, and in the direct vicinity of, each optical waveguide element.

2. An optical flat cable according to claim 1, characterised in that each optical waveguide element is assigned two tension/compression elements which are arranged diametrically to one another and in contact with the optical waveguide element.

3. An optical flat cable according to claim 1 or 2, characterised in that the optical waveguide element is a tight buffer tube .

4. An optical flat cable according to claim 1 or 2, characterised in that the optical waveguide element is a loose- or multifibre buffer tube.

5. An optical flat cable according to one of claims 1, characterised in that the tension/compression elements consist of a steel wire or a steel wire strand.

6. An optical flat cable according to one of claims 1, characterised in that the tension/compression elements consist of a synthetic resin.

7. An optical flat cable according to claim 6, characterised in that the tension/compression elements consist of fibre-reinforced synthetic resin, e.g. glass-fibre-reinforced polyester.

8. An optical flat cable according to one of claims 1, characterised in that the sheath consists of polyethylene.

9. An optical flat cable according to one of claims 1, characterised in that the sheath consists of polyvinyl chloride.

10. An optical flat cable according to one of claims 1 to 9, characterised in that the sheath consists of a halogen-free, fire-resistant synthetic resin.

11. An optical flat cable according to one of claims 1, characterised in that at least one of the large surfaces of the cable is of flat formation and has an adhesive coating with a protective film.

12. An optical flat cable according to one of claims 1, characterised in that a notch is provided in at least one of the large surfaces of the sheath.
